(19) United States
(12) Patent Application Publication
(10) Pub. No.: US 2007/0248441 A1
(43) Pub. Date: Oct. 25, 2007

(54) Refuse collection container and method of waste management

(76) Inventor: Eric Martinet, Cap Rouge (CA)

Correspondence Address: PAPARELLA & ASSOCIATES, PLC, 930 N. WASHINGTON AVE., LANSING, MI, 48906, US

(21) Appl. No.: 11/407,412

(22) Filed: Apr. 20, 2006

(51) Int. Cl. B65F 3/02

(52) U.S. Cl. 414/408

(57) ABSTRACT

A refuse collection container and method of waste management is disclosed. The refuse collection container includes a bin fabricated entirely from one or more non-rusting materials, wherein the bin is adapted to receive refuse therein. The bin includes hardware attached thereto, the hardware being fabricated from non-rusting materials, whereby the hardware is adapted to connect with a refuse collection vehicle.

### BACKGROUND OF THE INVENTION

The present invention pertains to refuse collection, and more specifically to a non-corroding refuse container and method of waste management.

Commercial waste receptacles are typically large containers used to store waste products within commercial waste streams. These containers range in size to hold from about 1 yards of waste, and may be as large as 30 yards, or more. Typically, the containers are made from a heavy gauge steel and painted for protection (i.e. rust protection). These waste containers must be durable, as they must withstand the physical stress of not only holding large quantities of trash, but also the stresses associated with being emptied by large trash hauling vehicles. In addition, the receptacle must withstand the outdoor environment, as well as the various corrosive liquids that may be contained therein. As such, even brand new receptacles quickly become unsightly, as they become dented, scratched, rusted and stained. Further, over time these containers rust. As such, the containers develop holes and other leaks thereby allowing the liquid waste products disposed therein to escape and pollute the surrounding environment. Additionally, as these containers are extremely heavy, the handling and transportation costs associated with them can be high. As such, existing waste containers allow contamination of the surrounding environment, are costly to operate and/or maintain, and quickly become unsightly.

Accordingly, a need exists for novell systems and methods which have, among other advantages, increased durability, while simultaneously being lighter, easier to operate, transport and maintain, and are more aesthetically pleasing than existing systems. Therefore, a refuse collection container and methods of waste management that solve the aforementioned disadvantages and having the aforementioned advantages are desired.

### SUMMARY OF THE PRESENT INVENTION

Refuse collection systems and methods thereof have garnered a sharp rise in awareness in both residential and commercial settings. One of the major factors contributing to this increased awareness is the heightened attention that has been brought on by environmental concerns. As such, the refuse collection industry is taking greater care in its collection and disposal efforts, and is changing many of its standard practices in order to alleviate, or at least mitigate, some of these environmental issues and to “cleanup” the industry's image. Hence, products and methods that can reduce the environmental impact of refuse collection and disposal, as well as improve the industry's image, are of great value: not only to the refuse collection industry, but to society as a whole.

One such area which is in need of improvement relates to the containers in which the refuse is collected. For example, typical commercial refuse containers range in size from 1 yard capacity, to over 30 yards. As such, in order to handle the vast amount of waste that can be stored therein, as well as the rigors of being emptied by large trash collection vehicles, these containers are fabricated from heavy gauge steel. As such, these containers are subject to rusting, leaking, and denting. These containers are also very heavy. More specifically, because of the weight of these containers, the transportation of the containers to and from the job-site is quite extensive, requires large trucks, and as such, large amounts of fuel are spent in transporting and handling these containers. Further, because these containers are fabricated from steel, because they remain on-site and are exposed to an exterior environment for many years, and because they are exposed to the liquid and other chemical products of the waste stream itself, over time these containers develop holes and leaks. Once developed, instead of holding the various fluids and chemicals, the containers allow the liquids to leach onto, and ultimately into the surrounding site whereon the refuse container is stored. Further, over time the outside of these containers rust. The containers also tend to become dented or otherwise disfigured from the various impacts received during its life-span, including repeated impacts with the refuse collection vehicle. As such, these containers tend to become an eyesore over time.

The aforementioned drawbacks and disadvantages of these previous waste collection systems have been identified and a solution is set forth herein by the inventive refuse container and method of waste management which includes, a refuse container comprising a bin at least partially fabricated from a non-woven fiber fabric, wherein the bin is adapted to receive refuse therein.

Another aspect of the present invention includes a refuse container comprising a bin fabricated entirely from one or more non-rusting materials, the bin including hardware attached thereto, wherein the hardware is adapted to connect with a refuse collection vehicle, the hardware being fabricated from non-rusting materials.

In another aspect of the present invention, a commercial refuse container comprises a bin which is at least partially fabricated from a non-woven fabric, wherein the bin is adapted to receive refuse therein, and the bin includes hardware attached thereto. The hardware is adapted to connect with a refuse collection vehicle to be emptied thereby and the hardware is fabricated from non-rusting materials.

And still in another aspect of the present invention, a commercial refuse container comprises a bin that is at least partially fabricated from a non-woven knitted fabric, wherein the bin is adapted to receive refuse therein, whereby the bin is fabricated entirely from non-rusting materials. The bin includes hardware attached thereto, whereby the hardware is adapted to connect with a refuse collection vehicle to be emptied thereby. The hardware is also fabricated from non-rusting materials, and the hardware is attached to the bin through a non-rusting first connection. The bin further includes at least one cover, whereby the cover is adapted to be movably affixed to a top of the bin via a non-rusting second connection. Further, all hardware, connections, and materials used on and in the refuse container are fabricated from non-rusting materials, and all hardware and connections attached to the refuse container are removably attached thereto.

In yet another aspect of the present invention, a method of selling, leasing, or renting a commercial refuse container includes: providing a refuse container comprising a bin fabricated entirely from one or more non-rusting materials, the bin including hardware attached thereto, the hardware adapted to connect with a refuse collection vehicle, the hardware fabricated from non-rusting materials; warranting the bin for a specified time; whereby if a purchaser, leaser, or renter of the refuse container encounters a break, imperfection, deformity or other defect in the bin during the specified time, the bin is repaired or replaced at a cost to the original purchaser, leaser, or renter that is below the original cost of the refuse container.

And still yet in another aspect of the present invention, a method of selling, leasing, or renting a commercial refuse container comprises: providing a refuse container including a bin fabricated entirely from one or more non-woven materials, the bin including hardware attached thereto, wherein the hardware is adapted to connect with a refuse collection vehicle; warranting the bin for a specified time; whereby if a purchaser, leaser, or renter of the refuse container encounters a break, imperfection, deformity or other defect in the bin during the specified time, the bin is repaired or replaced at a cost to the original purchaser, leaser, or renter that is below the original cost of the refuse container.

In yet another embodiment, a method of selling, leasing, or renting a commercial refuse container is disclosed and includes: providing a refuse container comprising a bin fabricated entirely from one or more non-rusting materials, the bin including hardware attached thereto, wherein the hardware is adapted to connect with a refuse collection vehicle; warranting the refuse container for one ore more specified times; whereby if a purchaser, leaser, or renter of one or more parts of the refuse container encounters a break, imperfection, deformity or other defect in the refuse container during the specified time, the one or more parts of the refuse container are repaired or replaced at a cost to the original purchaser, leaser, or renter that is below the original cost of the refuse container.

In still yet another aspect of the present invention, a method of selling, leasing, or renting a commercial refuse container includes: providing a refuse container including a bin; providing a purchaser, leaser, or renter of the refuse container a warranty for one or more specified times; whereby if the purchaser, leaser, or renter of the refuse container encounters a break or defect in the bin during the one or more specified times, the bin is repaired or replaced at a cost to the purchaser, leaser, or renter that is below the original cost of the refuse container.

In yet another aspect of the present invention, a method of selling, leasing, or renting a commercial refuse container includes: providing a refuse container; providing a purchaser, leaser, or renter of the refuse container a warranty for one or more specified times; whereby if the purchaser, leaser, or renter of the refuse container encounters a break or defect in one or more parts of the refuse container during the one or more specified times, the one or more parts of the refuse container are repaired or replaced at a cost to the purchaser, leaser, or renter that is below the original cost of the refuse container.

In another aspect of the present invention, a method of servicing a commercial refuse container comprises: providing a refuse container whereby all hardware and connections attached to the refuse container are removably attached thereto, thereby permitting the hardware and connections to be replaced; receiving a service call;

dispatching a service provider to a location where the refuse container is in need of service; fixing and replacing one or more affected parts by removing the affected part at the location of the refuse container.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The refuse collection container of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U. S. Patent and Trademark Office and the public generally, and especially the scientists, engineers, and practioners in the art who are not familiar with the patent or legal terms of phraseology, to learn quickly from a cursory inspection the nature and essences of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the refuse collection container of the present disclosure, its advantageous and the specific objects attained by its uses, reference should be made to the accompanying drawings and descriptive matter in which there are illustrated and described the preferred embodiments of the invention.

While embodiments of the refuse collection container are herein illustrated and described, it is to be appreciated that various changes, rearrangements and modifications maybe made therein, without departing from the scope of the invention as defined by the claims.

### BRIEF DESCRIPTION OF THE DRAWINGS

FIG. 1 is a front perspective view of a first embodiment of a refuse collection container of the present invention;

FIG. 2 is a rear perspective view of the refuse collection container of FIG. 1;

FIG. 3 is a side view of the refuse collection container of FIG. 1;

FIG. 4 is a bottom view of the refuse collection container of FIG. 1;

FIG. 5 is a sectional view of the refuse collection container of the present invention taken along line V-V of FIG. 4;

FIG. 6 is a rear perspective view of another embodiment of the refuse collection container of the present invention;

FIG. 7 is a side view of the refuse collection container of FIG. 6;

FIG. 8 is a bottom view of the refuse collection container of FIG. 6;

FIG. 9 is a sectional view of yet another embodiment of the refuse collection container of the present invention, taken along a line that corresponds to line V-V of FIG. 4; and

FIG. 10 is a sectional view of still another embodiment of the refuse collection container of the present invention, taken along a line that corresponds to line V-V of FIG. 4.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

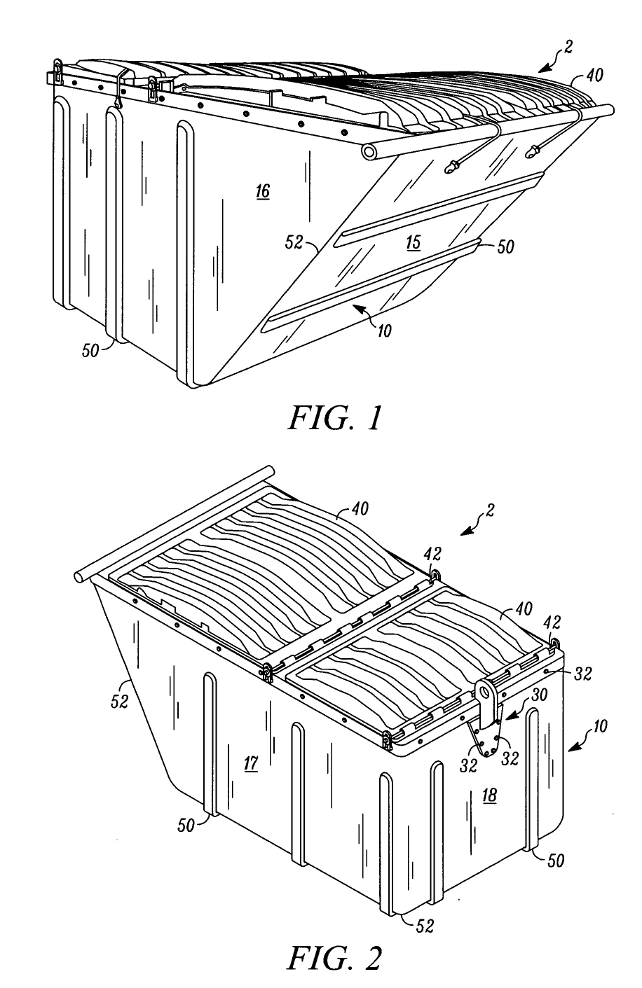

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. The dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

A brief synopsis of woven and non-woven fabrics is disclosed herein. The synopsis is meant to inform the reader as to the basics of the industry. That being said, it is not meant to be all-encompassing or all-inclusive, and a person having ordinary skill in the art will have a much higher familiarity with the products and processes disclosed herein and as such, the inventive refuse container is not meant to be limited to the content described herein.

Woven fabrics comprise two sets of interlaced fibers oriented in the 0° and 90° (length or warp, and width or weft) directions. The mechanical over/under interlacing of the weaving process bends, or crimps, the woven fibers. As a result, a 0/90 woven fabric can't match the performance of two unidirectional fabrics of the same weight stacked in 0/90 orientation. To achieve similar performance in a particular laminate, fabricators who use a woven fabric must therefore increase the total number of oriented layers. By contrast, multi-axial non-woven fabrics comprise two or more unidirectional layers at differing orientations, fixed together by, typically, polyester stitching thread or a polymer binder, or both. Because these methods introduce little or no fiber crimp, non-wovens are up to 50 percent stronger, by weight, than woven fabrics.

Each layer is typically oriented in one of four directions: length, width and plus/minus bias (0°, 90°, +45°, −45°). Standard configurations offered by multi-axial fabric suppliers include biaxial (0°, 90°), double bias (±45°), tri-axial warp (0°, ±45°), tri-axial weft (90°, ±45°) and quad-axial or quadraxial (0, 90°, ±45°). The fabric form enables multiple plies to be positioned correctly, quickly and easily.

Multi-axial fabrics also enable production of parts with higher fiber volume because un-crimped fibers facilitate better resin flow and the basic structure nests fiber bundles closer to one another, eliminating the interstices where resin accumulates in woven fabrics and chopped strand mats. For example, a multi-axial fabric will typically be wet out with 70 percent and 40 percent less resin than is required, respectively, to wet out a continuous-strand mat and a woven roving/continuous mat combination. As such, the processing of multi-axial fabrics is fast and efficient.

Multi-axial non-woven fabrics also present a considerable number of fabric variables, each of which can affect both handling during fabrication and performance of the end products. Fabric makers can vary stitch density, thread type, and/or binder type and wt-%, as well as the glass strand type and sizing. Further, fabric characteristics can play against one another. For example, drapability, can be increased by reducing stitch count and/or using a smaller quantity of polymer binder, but only with a corresponding loss of fabric stability (the ability to maintain fiber architecture and orientation during the molding process). Alternatively, a more open fabric, produced by using heavier input yarns, promotes drapability and wets out more easily as well. However, open fabrics tend to yield lower fiber volume fractions and increase part weight for a given strength. They are also more likely to print through, while the finer input rovings of closed fabrics produce better cosmetic features in the finished part. Therefore, products made with open fabrics may require surface veils or mats (i.e., chopped strand mats). Fabrics incorporating mats feature lower cost and increased drapability.

Stitch density can also be varied both in the number of stitch rows per inch (the gauge) and in the number of stitches per inch within each row (the stitch length). Generally, denser stitching maintains the designed fiber orientation better, as well as reduces unraveling and fraying. While this makes the fabric more stable, it decreases drapability and infusibility.

As used herein, the term non-woven fabric is meant to refer to fabrics that comprise knitted layers of directional rovings and may or may not include a supporting mat or veil. The layers are typically stitched together for better handling and dimensional stability, and precise alignment and positioning of the rovings yields high tensile strength and a smooth application. Of course, the layers are not required to be stitched together. As opposed to a woven fabric, a knit construction is made with a fiber roving (for example fiberglass roving) and knitting yarn (typically polyester yarn), and the roving is assembled into a fabric without crimping the roving, as a loom does in a weaving process. In a typical woven fabric, the roving is crimped in the weave. Thus, knitted fabrics can typically have a 17% higher modulus and up to 40% higher strength in a composite laminate due to enhanced load carrying capability of the straight roving's, versus the crimped roving's in a woven fabric. One such non-woven fabric is Knytex™, owned by Owens Corning, and described in further detail at www.owenscorning.net, the contents of which are wholly incorporated herein by reference.

As used herein, the term BTI™ fabric is meant to refer to bi-axial fabrics manufactured from Brunswick Technologies Inc., now Saint-Gobain BTI, Brunswick, Maine. BTI fabric can be woven or non-woven as the particular requirements dictate.

As used herein, the term bin is meant to include a container or other receptacle that can be used for the containment and/or holding of waste products, regardless of whether it is covered or not, and regardless of its geometry.

As used herein, the term rust is meant to include the term corrode. That is to say the term rust is not limited to the various powdery or scaly reddish-brown or reddish-yellow hydrated ferric oxides formed on iron and iron-containing materials, but also includes oxidation and other chemical reactions by other physical and/or chemical actions and encompass all actions and properties that destroy a metal or alloy.

As used herein, the term gel-coat is defined as simply a topcoat. The gel-coat may provide a cosmetic enhancement and may improve resistance to degradation from exposure to the environment. A gel-coat may also be pigmented or may be clear.

Refuse collection systems, and methods thereof, have garnered a sharp rise in awareness in both residential and commercial settings. One of the major factors contributing to this increased awareness is the increased attention that has been brought on by environmental concerns. As such, the refuse collection industry is taking greater care in its collection and disposal efforts, and is changing many of its standard practices in order to alleviate, or at least mitigate, some of these environmental issues and to “cleanup” the industry's image. Hence, products and methods that can reduce the environmental impact of refuse collection and disposal, as well as improve the industry's image, are of great value: not only to the refuse collection industry, but to society as a whole.

One such area which is in need of improvement relates to the containers in which the refuse is collected. For example, typical commercial refuse containers range in size from 1 yard capacity, to over 30 yards, and in order to handle the vast amount of waste that can be stored therein, as well as the rigors of being emptied by large trash collection vehicle, these containers are fabricated from heavy gauge steel. As such, these containers are subject to rusting, leaking, denting, and are heavy. More specifically, because of the heavy weight of the containers, the transportation of the containers to and from the job site is quite extensive, requires large trucks, and as such, large amounts of fuel are spent in transporting and handling these containers. Further, because these containers are fabricated from steel, because they remain on-site and are exposed to an exterior environment for many years, and because they are exposed to the liquid and other chemical products of the waste stream itself, over time these containers develop holes and leaks. Once developed, instead of holding the various fluids, chemicals, and other liquids, the containers allow the liquids to leach onto, and ultimately into, the surrounding site whereon the refuse container is stored. Further, over time, the outside of these containers rust and typically, the containers become dented or otherwise disfigured from the various impacts received during its life-span, including repeated impacts with the refuse collection vehicle. As such, these containers tend to become an eyesore over time.

Accordingly, a need exists for refuse collection container and waste management methods which have, among other advantages, increased durability, while simultaneously being lighter and easier to transport than existing systems. Therefore, a refuse collection system and method that solves the aforementioned disadvantages and having the aforementioned advantages is desired and disclosed herein.

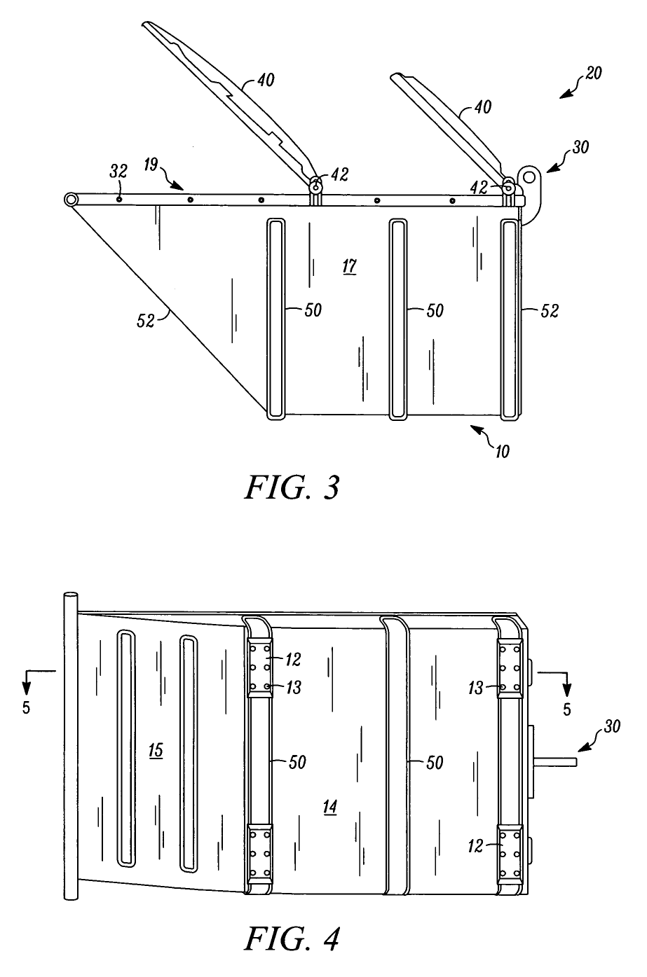

The disadvantages and drawbacks of the prior art are overcome through the refuse collection system of the present invention, wherein one preferred embodiment is disclosed in FIGS. 1-5. Referring now to FIG. 1, there is shown a refuse container comprising a bin or container 10 which is at least partially fabricated from a non-woven fiber fabric or other material 20, wherein the bin is adapted to receive refuse therein. In one preferred embodiment, bin 10 includes hardware 30 which is attached to bin 10 and is adapted to, at least temporarily, connect with a refuse collection vehicle to be emptied thereby.

Bin 10 may further include one or more feet 12 disposed on a bottom surface 14. In one preferred embodiment (FIG. 4) four feet 12 are disposed generally at the corners of bin 10 and help to prevent bottom surface 14 from eroding or wearing down. Additionally, although feet 12 may be permanently affixed to bottom surface 14, in one preferred embodiment, feet 12 are replaceably attached thereto through fasteners 13, for example, screws 13. Of course, other fasteners 13 may also be utilized. In this manner, feet 12 may be easily and readily replaced, on site if desired, without the requiring heat or externally powered tools. Further, these fasteners 13 may also be fabricated from a non-rusting material, such as, for example only, stainless steel. Additionally, although feet 12 may be fabricated from various materials, one preferred embodiment utilizes polytetrafluoroethylene (PTFE).

Refuse container or bin 10 is configured to store waste products within a waste stream. These waste products may be solid and/or liquid, natural and/or man-made, and may be benign and/or toxic. For example, the waste products may include the varied waste products generated from industrial, business, other commercial and/or home or residential waste streams. It is to be understood that refuse collection system 2 can be used in various environments, both indoors and out, and for commercial, industrial and/or residential use. However, for the sake of brevity, we will herein confine our discussion to the invention as it relates to the commercial, exterior environment. Of course, this is not meant to be limiting in any way.

The specific configurations and features of bin 10 may vary according to specific requirements. With respect to commercial refuse collection systems, commercial bins 10 come in various shapes and various sizes, and may range from about 2 cubic yards to about 8 cubic yards, and can be found to hold 30 cubic yards or more. In one preferred embodiment, bin 10 is generally rectangular in shape and is fabricated into a one-piece or unitary construction utilizing, at least partially, a non-woven fabric 20. In another preferred embodiment, non-woven fabric 20 includes multiple layers 22 of a non-woven knitted multi-axial fiberglass mat 24, as for example Knytex™ from Owens-Coming Fiberglas Technology Inc. In yet another embodiment, a biaxial fabric (BTI™) from Brunswick Technologies, inc. is used, and further, these biaxial fabrics may be woven or non-woven.

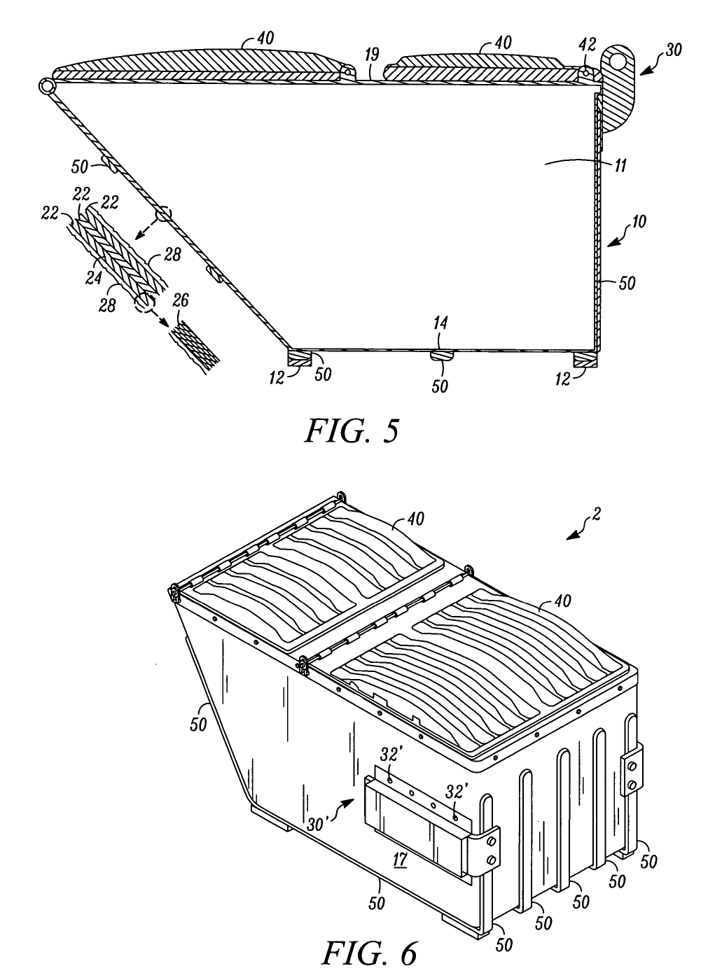

Non-woven or knitted fiberglass fabric or mat 20 comprises knitted layers of directional rovings 26 (FIG. 5). The layers are typically stitched together for better handling and dimensional stability. Precise alignment and positioning of rovings 26 gives high tensile strength and a smooth application. Of course, fiber other than fiberglass, single-axial, a single layer, and woven mats may also be used in-whole or in-part. In one preferred embodiment, 3 layers 22 or coats of Knytex™ marine laminate CDM 3610 are used to fabricate bin 10. In another embodiment, a BTI™ product is used.

Although the container made be made of “regular” fiberglass (i.e. built up from individual layers of matting and resin), one preferred material uses a fiberglass material from Brunswick Technologies (BTI™) that is used in the manufacture of boat hulls. This type of fiberglass can be ordered in various thicknesses (layers) and these “layers” do not have to be laid individually. Instead, the entire thickness, or all of the layers, are laid at a single time with the addition of a high quality resin. This makes the fiberglass more durable, as individually layered fiberglass may delaminate under stress. The BTI™ technology does not delaminate, is strong, and yet very flexible. Additionally, the resin used in this process does not require wax. The inclusion of wax in the resin may make the fiberglass more brittle as the layers of fiberglass are easier to separate. In this embodiment, the container uses a thickness of BTI™ fiberglass which includes 7 layers, and each layer is 7.5 oz. As such, the container is very flexible, absorbs impact, and does not break or fracture easily. If “regular” fiberglass is used, the Knytex™ or BTI™ material may be used on the bottom of the container for increased strength. The BTI™ products also have the advantage of being able to be applied with a gun and sprayed on a mold in a single step.

Additionally, the outer surface of bin 10 may be coated with a gelcoat layer 28 and in one preferred embodiment, is coated with an isophthalic gelcoat which is applied over the resin coat for a smother finish. Both the resin coat and gel-coat may be colored. This allows the color to permeate the entire product through its depth. Further yet, one or more layers 22 of non-woven fabric 20 may also contain a pigment therein or applied thereto. As such, bin 10 will remain pigmented even when scratched, and will not fade, chip, or peel.

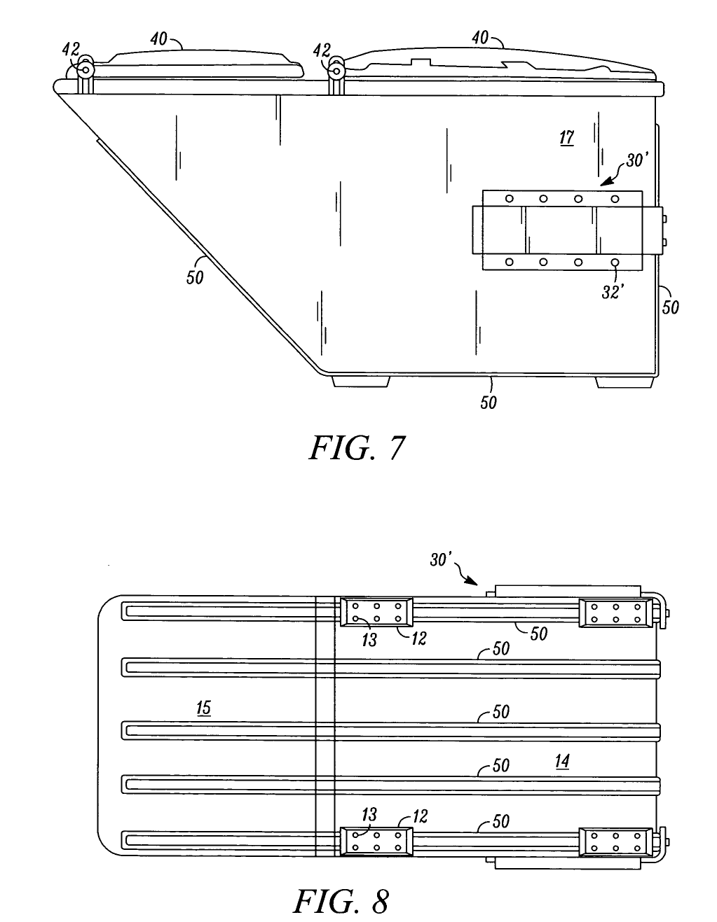

Hardware 30 is attached to bin 10 through a first connection 32 and is configured to connect with a refuse collection vehicle such that the refuse collection vehicle may empty bin 10. Hardware 30 comprises various methods, mechanisms, and designs, all of which are well known in the art. However, unlike existing designs, hardware 30 is non-rusting and is replaceably attached to bin 10 utilizing a first connection 32, for example, by replaceable fasteners 32. In this manner hardware 30 may be easily and readily replaced, on-site if desired, without the requirement of heat or externally powered tools (electricity). FIGS. 1-5 illustrate an embodiment of hardware 30 which is configured to be emptied by a refuse collection vehicle using hardware 30 which is attached to a rear surface 18 (i.e. a rear-loading design) as is known in the art. FIGS. 6-8 illustrate hardware 30′, attached through first connection 32′, which is configured to be emptied by a refuse collection vehicle using hardware 30′ attached to sides 16 and 17 (i.e. a front-loading design) as is known in the art.

The specific configuration, that is to say the specific mechanisms, and design of hardware 30 and 30′ may vary according to specific requirements and are well known in the art. Previously these mechanisms have been fabricated from materials that are, among other things, heavy and corrode or rust, and heretofore have included only heavy gauge ferrous steel and other iron containing products. Conversely, hardware 30 and 30′ are fabricated from non-rusting materials. For example, in one preferred embodiment aluminum is used. In this manner, the overall weight of bin 10 is reduced, and the since the aluminum hardware will not rust, the appearance of bin 10 remains aesthetically pleasing. Of course, other non-rusting materials may be used. For example, stainless steel, various plastics, other non-ferrous metals, and the like. As described above, hardware 30 is replaceably attached to bin 10 utilizing first connection 32 which includes replaceable fasteners. These fasteners may also be fabricated from one or more non-rusting materials, and may include for example, stainless steel screws 32. Of course other fasteners, adhesives, and other methods of attachment may be used. Additionally, other hardware and connections may be affixed to bin 10 as are commonly known in the art. For example, connections of various types, other lids, covers, straps, bumpers, and the like.

Refuse collection container 2 may also include one or more tops, covers, or lids 40 mounted to a top 19 of bin 10 through one or more second connections 42. Second connections 42 include various methods, mechanisms, and designs, all of which are well known in the art. For example, two rotatably mounted lids 40 may be attached to top 19 to allow access to an inside 11 of bin 10 when in use, while allowing bin 10 to be covered when not in use, thereby keeping the elements and animals out of inside 11 of bin 10. The specific configuration, that is to say the specific methods, mechanisms, and design of tops 40 may vary according to specific requirements and are known in the art. With respect to second connection 42, these connections have heretofore been fabricated from materials that are, among other things, heavy and corrode or rust, and have included only heavy gauge ferrous steel and other iron containing products. Conversely, second connection 42 is fabricated from one or more non-rusting materials. For example, in one preferred embodiment, stainless steel is used. In this manner, second connection 42 will not rust and the appearance of bin 10 remains aesthetically pleasing. Of course, other non-rusting materials may be used, such as aluminum, various plastics, other non-ferrous metals, and the like. Second connection 42 is also replaceably attached to bin 10 utilizing replaceable fasteners. These fasteners may also be fabricated from a non-rusting material and may include, for example, stainless steel screws.

As described above, in one preferred embodiment, bin 10, feet 12, fabric 20, gel-coat 28, hardware 30, lid 40, first and second connections 32 and 42, respectively, fasteners 13, and any and all other hardware, connections, and materials used in and on refuse container 2 are fabricated from non-rusting materials. Further, all attachments and connections to bin 10 may be removably attached thereto, thereby permitting, for example, feet 12, hardware 30, and lid 40 to be replaced. Further yet, feet 12, hardware 30, and lid 40 are removably attached in such a manner as to allow replacement without the need for electricity or heat, for example, by stainless steel screws. In this preferred embodiment bin 10 is fabricated from a non-woven fiberglass, while hardware 30 is aluminum and attached via stainless steel screws 32. Plastic lids 40 are attached via stainless steel screws and aluminum rods 42.

While one preferred embodiment has been described, the specific characteristics of refuse collection system 2 may vary according to the specific requirements of the end user. Although the preferred embodiment utilizes a one piece construction for bin 10, bin 10 may be fabricated from numerous parts. In addition, refuse collection system 2 may be fabricated by numerous methods such as forming, molding, or machining.

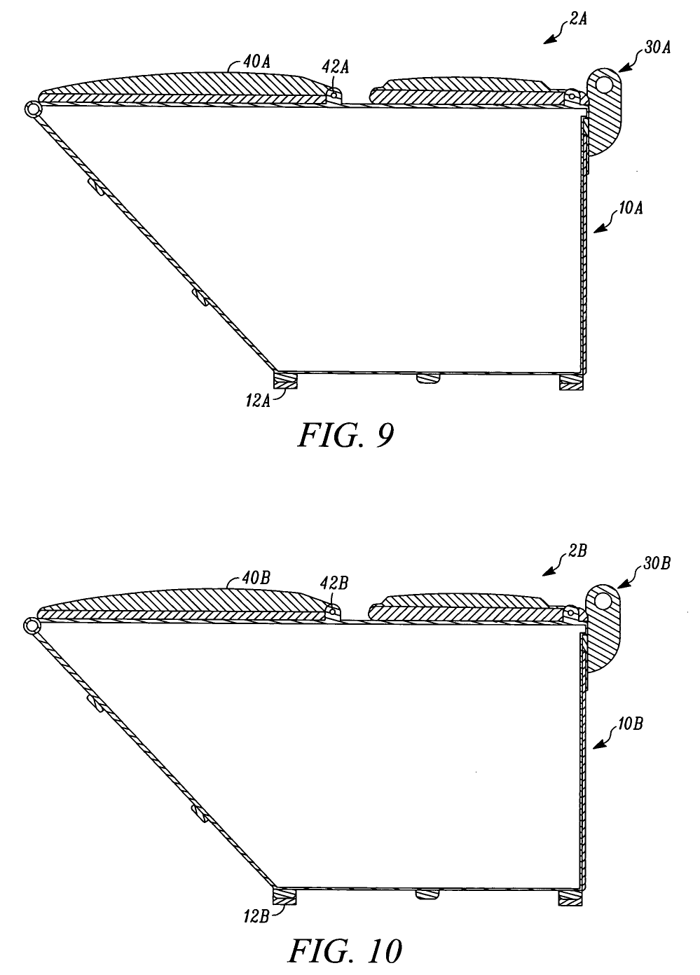

In another embodiment (FIG. 9), a refuse container system 2A includes a bin 10A fabricated entirely from one or more non-rusting materials 21 and includes hardware 30A attached thereto, wherein hardware 30A is adapted to connect with a refuse collection vehicle and is also fabricated from non-rusting material 21′, which may be the same as or different from non-rusting material 21. In this embodiment, all of the materials used in the construction of container system 2A are non-rusting. That is to say, they may include any non-rusting material, whether woven or non-woven, including but not limited to fiberglass, metal, plastic. In one embodiment the non-rusting components include bin 10A, material 21, and hardware 30A. In another embodiment, the non-rusting components include bin 10A, feet 12A, material 21, gel-coat 28A, hardware 30A, lid 40A, first and second connections 32A and 42A, respectively, fasteners 13, and any and all other hardware, connections, and materials used in and on refuse container 2. Further, all attachments and connections to bin 10A may be removably attached thereto, thereby permitting, for example, feet 12A, hardware 30A, and lid 40A to be easily replaced. Further yet, feet 12A, hardware 30A, and lid 40A are removably attached in such a manner as to allow replacement without the need for electricity or heat, for example, by stainless steel screws 13A. The materials used in the construction of container system 2A may be, for example: fiberglass, including strands and/or fabric, woven and/or non-woven; aluminum; stainless steel; non-ferrous metals; plastics, and the like. One preferred embodiment includes a bin 10A fabricated from a fiberglass, and includes aluminum hardware 30A attached via stainless steel screws 32A, and plastic lids 40A attached via stainless steel screws and aluminum rods 42A. Therefore, most or all parts of container system 2A will not rust and as such, the container will not develop holes or leaks over time, and will remain more aesthetically pleasing over a longer time.

The specific configuration, that is to say the specific mechanisms and design of refuse container system 2A, may vary according to specific requirements and are known in the art. Heretofore these mechanisms have been fabricated from materials that are, among other things, heavy, and have included only heavy gauge ferrous steel and other iron containing products that rust or corrode. Conversely, refuse container system 2A is fabricated from non-rusting materials. For example, in one preferred embodiment, all parts and attachments of container system 2A are fabricated from non-rusting materials and include aluminum, fiberglass, and stainless steel. Of course, other non-rusting materials may also be used.

In yet another embodiment (FIG. 10), a refuse container system 2B includes a bin 10B at least partially fabricated from a non-woven fabric 20, wherein bin 10B is adapted to receive refuse therein. Bin 10B also includes hardware 30B, attached thereto, which is adapted to connect with a refuse collection vehicle to be emptied thereby, whereby hardware 30 is fabricated from non-rusting materials 21.

In this embodiment, most or all of the materials used in the construction of container bin 10B are non-woven fabrics 20. While all hardware and other components attached thereto, such as for example, hardware 30B, are non-rusting. The non-rusting components may include feet 12B, hardware 30B, lid 40B, first and second connections 32B and 42B, respectively, fasteners 13B, and any and all other hardware, connections, and materials used in and on bin 10B. Further, all attachments and connections to bin 10B may be removably attached thereto as previously described. In one embodiment, bin 10B is fabricated from Knytex™ or BTI™ fiberglass, and hardware 30B and first and second connections 32B and 42B are fabricated from non-rusting materials such as aluminum, stainless steel, and the like.

In another embodiment, a method of selling, leasing, or renting a commercial refuse container systems 2 includes the steps of providing a refuse container system 2 comprising a bin 10 fabricated entirely from one or more non-woven fabrics 20, wherein bin 10 includes hardware 30 attached thereto. Hardware 30 is adapted to connect with a refuse collection vehicle. Bin 10 is then warranted for one or more specified times, whereby if a purchaser, leaser, or renter of the refuse container encounters a break, imperfection, deformity or other defect in the bin during the one or more specified times, the bin is repaired or replaced at a cost to the original purchaser, leaser, or renter that is below the original cost of the refuse container

In this embodiment, bin 10 is fabricated from a non-woven fabric 20, for example Knytex™ or BTI™ as described previously. Because existing refuse collection systems in use today are fabricated to include, at least partially, components that are ferrous or rust, and do rust over time, the fabricators, dealers and other distributors of these containers are not able to warrant them for a long period of time. In no case is a lifetime warranty available today. For example, in one embodiment, the fabricator, dealer or other distributor warrants bin 10 for as long as the original purchaser owns system 2, i.e. the lifetime of the purchaser, and if the original purchaser encounters a break, imperfection, deformity or other defect in the bin during the purchasers lifetime, the bin is repaired or replaced for free. Of course, various other time frames, cost structures, and owners other than the original purchaser may also be warranted as the particular requirements dictate.

In yet another embodiment, a method of selling, leasing, or renting a commercial refuse container systems 2A includes the steps of providing a refuse container system 2A comprising a bin 10A fabricated entirely from one or more non-rusting materials 21, wherein bin 10A includes hardware 30A attached thereto, and is fabricated from non-rusting materials 21′, whereby hardware 30A is adapted to connect with a refuse collection vehicle. Bin 10A is then warranted for one or more specified times, whereby if a purchaser, leaser, or renter of the refuse container encounters a break, imperfection, deformity or other defect in the bin during the one or more specified times, the bin is repaired or replaced at a cost to the original purchaser, leaser, or renter that is below the original cost of the refuse container.

In this preferred embodiment bin 10 is fabricated from a non-rusting material 21 (for example a woven or non-woven fabric which may include fiberglass). The fabricator, dealer or other distributor may then warrant bin 10A for as long as the original purchaser owns system 2A, and may warrant hardware 30A, for example, for 5 years. Of course, various time frames, and owners other than the original purchaser may also be warranted as the particular requirements dictate.

Another method of selling, leasing, or renting a commercial refuse container includes providing a refuse container 2A comprising a bin 10A fabricated entirely from one or more non-rusting materials 21, for example, woven or non-woven fiberglass fabric. The bin 10A also includes hardware 30A attached thereto, wherein hardware 30A is adapted to connect with a refuse collection vehicle. In this method, refuse container 2A is warranted for one or more specified times, whereby if a purchaser, leaser, or renter of the refuse container encounters a break, imperfection, deformity or other defect in any part of refuse container 2A during the one or more specified times, refuse container 2A is repaired or replaced at a cost to the original purchaser, leaser, or renter that is below the original cost of the refuse container.

In still yet another embodiment, a method of selling, leasing, or renting a commercial refuse container comprises providing a refuse container 2, and providing the purchaser, leaser, or renter of refuse container 2 a warranty for one or more specified times, whereby if the purchaser, leaser, or renter of refuse container 2 encounters a break or defect in bin 10 during the one or more specified times, bin 10 is repaired or replaced at a cost to the purchaser, leaser, or renter that is below the original cost of refuse container 2.

In yet further another embodiment, a method of selling, leasing, or renting a commercial refuse container comprises providing a refuse container 2, and providing the purchaser, leaser, or renter of refuse container 2 a warranty for one or more specified times, whereby if the purchaser, leaser, or renter of refuse container 2 encounters a break or defect in one or more parts of refuse container 2 during the one or more specified times, the one or more defective parts of refuse container 2 are repaired or replaced at a cost to the purchaser, leaser, or renter that is below the original cost of refuse container 2.

Another embodiment of the present invention includes, a method of servicing a commercial refuse container which includes, providing a refuse container whereby all hardware and connections attached to the refuse container are removably attached thereto, thereby permitting the hardware and connections to be replaced. Then after receiving a service call, a service provider is dispatched to the location where the refuse container is in need of service, and one or more of the affected parts are then fixed and/or replaced by removing and replacing the affected part at the location of the refuse container.

Because existing refuse collection systems in use today are fabricated from components that rust and dent, the containers are heavy, bulky, and problematic to move. As such, when they need to be fixed, serviced and/or repaired, they may be serviced on site rather than attempting to have them moved. However, in order to fix holes, remove hardware, dents, and perform a wide variety of other varied maintenance tasks, both a heat source and externally powered tools requiring electricity are needed. As such, the service vehicles need to carry highly pressurized and flammable gasses for torches, and generators for electricity. With refuse collection system 2, no such heat source or electricity is required as all of the parts are easily removable and replaceable (i.e. easily assembled and disassembled). For example, all features may be replaced by utilizing hand tools that do not require an external power source such as a generator or extension cord.

Refuse collection container 2 may be fabricated in numerous ways and by varied processes. In one preferred embodiment, container 2 is fabricated using a hand lay up process. This process comprises layering non-woven fabric 20 or non-rusting material 21 upon a male mold which has been coated with gel-coat 28. For example, a knitted fabric such as reinforced Knytex™ is laid onto the male mold which has been coated with an isophthalic gel-coat layer 28. Additional layers 22 of fabric 21 are subsequently laid down until the desired number of layers 22 is achieved. In one preferred embodiment, three layers are used. Additional layers 22 may also be used for, and in, areas requiring reinforcement. In one particular embodiment (FIGS. 1-5), 2 extra layers 22 of fabric 21 are used in each reinforced area. These reinforced areas may include reinforcement members 50 disposed along sidewalls 16, 17, and front and rear surface 15, and 18, respectively. The corners 52 may also be reinforced in this manner. The fabric is then impregnated with a resin during the layering process, and this resin may be colored if desired. In this manner, the colorant is dispersed throughout the product and therefore, will not fade, chip, or loose its color. The resin is rolled on, impregnates, and adheres layers 22 of fabric 21. Finally, a top layer of gel-coat 28 is rolled on the top surface or upper layer of fabric 21. This rolling process is used for the resin coat and gel-coat 28 and helps to disperse the colorant, as well as helps to remove air pockets that may be disposed within and between fabric layers 22. This also helps to produce a consistent and smooth finish. Once the colored resin and gel-coat 28 cures, fiberglass container 10 is removed from the mold and hardware 30 is installed. However, the fabrication of refuse collection container 2 may vary according to specific requirements and may be done manually or by an automated process. Although the preferred embodiment utilizes a one-piece configuration, multiple pieces may also be utilized and assembled by various means such as fasteners and welding, as well as any other technique known in the art.

Advantageously, the refuse collection system and method of waste management of the present invention allows the fabrication of a collection bin wherein all of the materials used in the construction of the container are non-corrosive and non-rusting, including the hardware. As such, neither the container nor the hardware will rust or corrode. Further, the container is not painted, but rather infused with a pigment and therefore, the color will not flake off, chip, peel, or fade. Further, the various resins, gels and colorants may include various additives such that the system may be made to be mold resistant and UV stabilized and/or resistant. Because the container is fabricated from, in one embodiment, fiberglass, the container can bend and flex rather than dent. Also because the fiberglass material is much lighter, incidental vehicle damage will also be reduced. And, since the material is impervious to corroding products such as salt, acid rain, and the like, no holes or leaks will develop over time. As such, the containers are environmentally friendly as they do not allow the liquids stored therein to leach out. Further, these materials are not conductive and therefore, pose no electrocution hazards. Additionally, the inside of the containers are smooth, and stay smooth over time, so the trash does not “stick” to the sides of the container.

Further advantages of this system include the ability for the system to be easily repaired on site, without the need for special tools, electricity, or flame. As already mentioned, the containers are much lighter and therefore, transportation costs are reduced, as is the ware-and-tear on the lifting trucks. Also, since the containers are lighter, the containers can carry heavier loads than currently allowed in existing systems. Therefore, a container system has been efficiently fabricated and designed to be aesthetically pleasing, while being engineered to resist the effects of corrosion. Consequently, the embodiments of the preferred invention disclosed herein reveal a refuse collection system which is more robust than existing designs, while being lighter and more environmentally friendly. Additionally, the refuse collection system of the present invention is more aesthetically appealing than existing containers.

The solutions offered by the invention disclosed herein have thus been attained in an economical, practical, and facile manner. To whit, a novel refuse collection system which is cost effective, easily installed, strong, and aesthetically pleasing has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A refuse container comprising:
a bin at least partially fabricated from a non-woven fiber fabric, wherein the bin is adapted to receive refuse therein.

2. The refuse container of claim 1, wherein:
the bin includes hardware attached thereto, the hardware adapted to connect with a refuse collection vehicle to be emptied thereby.

3. The refuse container of claim 2, wherein:
the hardware is fabricated from non-rusting materials.

4. The refuse container of claim 2, wherein:
the hardware is attached to the bin through a replaceable non-rusting first connection.

5. The refuse container of claim 1, wherein:
the bin is of unitary construction.

6. The refuse container of claim 1, wherein:
the bin includes feet disposed on a bottom surface thereof,
the feet including a polytetrafluoroethylene layer.

7. The refuse container of claim 6, wherein:
the feet are replaceably attached to the bin.

8. The refuse container of claim 1, wherein:
the bin includes at least one cover, the cover movably affixed to a top of the bin via a non-rusting second connection.

9. The refuse container of claim 1, wherein:
wherein the non-woven fiber fabric is a non-woven fiberglass.

10. The refuse container of claim 9, wherein:
the bin is fabricated from multiple layers of the non-woven fiberglass.

11. The refuse container of claim 10, wherein:
the multiple layers of non-woven fiberglass are adhered together using a resin.

12. The refuse container of claim 11, wherein:
the resin includes a colorant.

13. The refuse container of claim 9, wherein:
the bin includes a layer of gel-coat.

14. The refuse container of claim 13, wherein:
the gel-coat includes a colorant.

15. The refuse container of claim 9, wherein:
the non-woven fiberglass at least partially includes Knytex™.

16. The refuse container of claim 9, wherein:
the non-woven fiberglass at least partially includes BTI™.

17. The refuse container of claim 1, wherein:
all hardware, connections, and materials used on and in the refuse container are fabricated from non-rusting materials.

18. The refuse container of claim 1, wherein:
all hardware and connections attached to the refuse container are removably attached thereto, thereby permitting the hardware and the connections to be replaced.

19. The refuse container of claim 18, wherein:
the hardware and connections are removably attached in such a manner as to allow replacement without the need for externally powered tools or heat.

20. A refuse container comprising:
a bin fabricated entirely from one or more non-rusting materials, wherein the bin is adapted to receive refuse therein, the bin including hardware attached thereto;
the hardware adapted to connect with a refuse collection vehicle, the hardware fabricated from non-rusting materials.

21. The refuse container of claim 20, wherein:
the hardware is attached to the bin through a replaceable non-rusting first connection.

22. The refuse container of claim 20, wherein:
the bin includes feet disposed on a bottom surface thereof; the feet replaceably attached to the bin.

23. The refuse container of claim 20, wherein:
the bin includes at least one cover, the cover movably affixed to a top of the bin via a non-rusting second connection.

24. The refuse container of claim 20, wherein:
wherein at least one of the one or more non-rusting materials of the bin includes a non-woven fiberglass.

25. The refuse container of claim 20, wherein:
the hardware is fabricated from aluminum.

26. The refuse container of claim 20, wherein:
all hardware, connections, and materials used on and in the refuse container are fabricated from non-rusting materials.

27. The refuse container of claim 20, wherein:
all hardware and connections attached to the refuse container are removably attached thereto, thereby permitting the hardware and the connections to be replaced.

28. The refuse container of claim 27, wherein:
the hardware and connections are removably attached in such a manner as to allow replacement without the need for externally powered tools or heat.

29. A commercial refuse container comprising:
a bin at least partially fabricated from a non-woven fabric, wherein the bin is adapted to receive refuse therein, the bin including hardware attached thereto;
the hardware adapted to connect with a refuse collection vehicle to be emptied thereby, the hardware fabricated from non-rusting materials.

30. The refuse container of claim 29, wherein:
the bin is fabricated entirely from one or more non-rusting materials.

31. The refuse container of claim 29, wherein:
the hardware is attached to the bin through a replaceable non-rusting first connection.

32. The refuse container of claim 29, wherein:
the bin includes feet replaceably attached to a bottom surface of the bin.

33. The refuse container of claim 29, wherein:
the bin includes at least one cover, the cover movably affixed to a top of the bin via a non-rusting second connection.

34. The refuse container of claim 29, wherein:
wherein the non-woven fiber fabric is a non-woven fiberglass.

35. The refuse container of claim 34, wherein:
the bin is fabricated from multiple layers of the non-woven fiberglass.

36. The refuse container of claim 35, wherein:
the multiple layers of non-woven fiberglass are adhered together using a resin.

37. The refuse container of claim 36, wherein:
the resin includes a colorant.

38. The refuse container of claim 29, wherein:
the bin includes a layer of gel-coat.

39. The refuse container of claim 38, wherein:
the gel-coat includes a colorant.

40. The refuse container of claim 29, wherein:
all hardware, connections, and materials used on and in the refuse container are fabricated from non-rusting materials.

41. The refuse container of claim 29, wherein:
all hardware and connections attached to the refuse container are removably attached thereto, thereby permitting the hardware and the connections to be replaced.

42. The refuse container of claim 41, wherein:
the hardware and connections are removably attached in such a manner as to allow replacement without the need for externally powered tools or heat.

43. A commercial refuse container comprising:
a bin at least partially fabricated from a non-woven knitted fabric, wherein the bin is adapted to receive refuse therein, the bin fabricated entirely from non-rusting materials, the bin including hardware attached thereto;
the hardware adapted to connect with a refuse collection vehicle to be emptied thereby, the hardware fabricated from non-rusting materials, whereby the hardware is attached to the bin through a non-rusting first connection;
the bin further including at least one cover, whereby the cover is adapted to be movably affixed to a top of the bin via a non-rusting second connection;
whereby all hardware, connections, and materials used on and in the refuse container are fabricated from non-rusting materials;
whereby further, all hardware and connections attached to the refuse container are removably attached thereto.

44. The refuse container of claim 43, wherein:
wherein the non-woven fiber fabric is a non-woven fiberglass.

45. The refuse container of claim 44, wherein:
the bin is fabricated from multiple layers of the non-woven fiberglass.

46. The refuse container of claim 45, wherein:
the multiple layers of non-woven fiberglass are adhered together using a resin.

47. The refuse container of claim 46, wherein:
the resin includes a first colorant.

48. The refuse container of claim 47, wherein:
the bin includes a layer of gel-coat.

49. The refuse container of claim 48, wherein:
the gel-coat includes a second colorant.

50. The refuse container of claim 49, wherein:
all hardware and connections attached to the refuse container are removably attached thereto, thereby permitting the hardware and the connections to be replaced.

51. The refuse container of claim 50, wherein:
the hardware and connections are removably attached in such a manner as to allow replacement without the need for externally powered tools or heat.

52. A method of selling, leasing, or renting a commercial refuse container comprising:
providing a refuse container comprising a bin fabricated entirely from one or more non-rusting materials, the bin including hardware attached thereto, the hardware adapted to connect with a refuse collection vehicle, the hardware fabricated from non-rusting materials; and
warranting the bin for a specified time, whereby if a purchaser, leaser, or renter of the refuse container encounters a break, imperfection, deformity or other defect in the bin during the specified time, the bin is repaired or replaced at a cost to the purchaser, leaser, or renter that is below an original cost of the refuse container.

53. The method of claim 52, wherein:
the providing step includes providing hardware which is attached to the bin through a replaceable non-rusting first connection.

54. The method of claim 53, wherein:
the providing step includes providing at least one cover, the cover movably affixed to a top of the bin via a non-rusting second connection.

55. The method of claim 54, wherein:
the providing step includes providing a non-woven fiberglass for the one or more non-rusting materials of the bin.

56. The method of claim 55, wherein:
the providing step includes providing hardware which is fabricated from aluminum.

57. The method of claim 52 wherein:
the providing step includes providing a refuse container wherein all hardware, connections, and materials used on and in the refuse container are fabricated from non-rusting materials.

58. The method of claim 52, wherein:
the providing step includes providing a refuse container wherein all hardware and connections attached to the refuse container are removably attached thereto, thereby permitting the hardware and the connections to be replaced.

59. The method of claim 58, wherein:
the providing step includes providing a refuse container wherein the hardware and connections are removably attached in such a manner as to allow replacement without the need for externally powered tools or heat.

60. The method of claim 52, wherein:
the warranting step includes warranting a purchaser who is an original purchaser.

61. The method of claim 52, wherein:
the specified time of the warranting step includes a lifetime of the purchaser.

62. The method of claim 52, wherein:
the specified time of the warranting step is greater than 10 years.

63. The method of claim 52, wherein:
the cost of the warranting step to the purchaser, leaser, or renter is zero.

64. A method of selling, leasing, or renting a commercial refuse container comprising:
providing a refuse container including a bin;
providing a purchaser, leaser, or renter of the refuse container a warranty for one or more specified times;
whereby if the purchaser, leaser, or renter of the refuse container encounters a break or defect in the bin during the one or more specified times, the bin is repaired or replaced at a cost to the purchaser, leaser, or renter that is below an original cost of the refuse container.

65. A method of servicing a commercial refuse container comprising:
providing a refuse container whereby all hardware and connections attached to the refuse container are removably attached thereto, thereby permitting the hardware and connections to be replaced;
receiving a service call;
dispatching a service provider to a location where the refuse container is in need of service;
fixing and replacing one or more affected parts by removing the affected part at the location of the refuse container.
